(19) United States
(12) Patent Application Publication
(10) Pub. No.: US 2007/0037008 A1
(43) Pub. Date: Feb. 15, 2007

(54) Wear-resistant coating mixture and article having the wear-resistant coating mixture applied thereto

(75) Inventors: Thomas Froats Broderick, Springboro, OH (US); Ronald Lance Galley, Mason, OH (US); Clifford Earl Shamblen, Blue Ash, OH (US); David Edwin Budinger, Loveland, OH (US); Reed Roy Oliver, Cincinnati, OH (US); Roger Owen Barbe, Cincinnati, OH (US)

Correspondence Address: MCNEES, WALLACE & NURICK LLC, 100 PINE STREET, PO BOX 1166, HARRISBURG, PA, 17108-1166, US

(73) Assignee: GENERAL ELECTRIC COMPANY, Schenectady, NY (US)

(21) Appl. No.: 11/188,820

(22) Filed: Jul. 25, 2005

(51) Int. Cl. B32B 15/00; B32B 9/00; B32B 19/00

(52) U.S. Cl. 428/678; 428/689; 428/697; 428/627

(57) ABSTRACT

An article includes a substrate having a surface, and a wear-resistant coating mixture applied to the surface of the substrate. The wear-resistant coating mixture has a nickel-base alloy first component with a first-component solidus temperature of from about 1775° F. to about 1825° F. and with a nominal composition in weight percent of (i) from about 6 to about 8 percent chromium, from about 2.5 to about 3.5 percent iron, from about 4 to about 5 percent silicon, from about 2.75 to about 3.5 percent boron, balance nickel and minor elements, or (ii) about 0.5 maximum percent iron, from about 4 to about 5 percent silicon, from about 2.75 to about 3.5 percent boron, balance nickel and minor elements, and a second component having a second-component solidus temperature greater than the first-component solidus temperature. The second component is either more abrasive or more lubricious than the first component.

This invention relates to a coating that may be applied to the surface of an article substrate and, in particular, to a multicomponent coating whose properties may be controlled by the selection of the type and amount of the components.

### BACKGROUND OF THE INVENTION

In an aircraft gas turbine (jet) engine, air is drawn into the front of the engine, compressed by a shaft-mounted compressor, and mixed with fuel. The mixture of air and fuel is burned, and the hot combustion gases are passed through a turbine mounted on the same shaft. The flow of combustion gas turns the turbine by impingement against an airfoil section of the turbine blades and vanes, which turns the shaft and provides power to the compressor and fan. In a more complex version of the gas turbine engine, the compressor and a high-pressure turbine are mounted on one shaft, and the fan and low-pressure turbine are mounted on a separate shaft. The hot exhaust gases flow from the back of the engine, driving it and the aircraft forward.

The compressor and turbine of the gas turbine engine include many pairs of components that contact and rub against each other during operation of the engine. The contact and rubbing can cause wear damage to one or both of the components, if allowed to proceed uncontrolled. Coatings are often placed onto the surfaces of one or both of the components in order to protect against the damage. In some cases it may be desirable to place a coating on one or both of the components in order to resist the wear damage. Such a coating may be hard and abrasive to resist wear damage, or more lubricious to reduce the coefficient of friction and thence the wear damage.

A variety of techniques are used to apply such wear-resistant coatings to components of gas turbine engines and in other applications. Examples of such techniques include flame spraying, electroplating, and brazing. Each of the techniques has advantages and disadvantages, but in general it is desired to apply the coating of the proper thickness and with acceptable quality and performance to the surface in a controlled manner at minimal cost, in both new-make and repair applications as appropriate.

There is always a need for improved coating-application technology. The present invention fulfills this need, and further provides related advantages.

### SUMMARY OF THE INVENTION

The present approach provides a wear-resistant coating mixture and an approach for applying a wear-resistant coating of the mixture to a surface of a component substrate. The wear-resistant coating mixture is formed of two (or more) components, one of which is a lower-melting component and the other of which is a higher-melting component. The lower-melting first component is a nickel-base alloy having a solidus temperature of about 1775° F.-1825° F., which is lower than the melting temperature of other available lower-melting nickel-base compositions used in brazing mixtures. The use of such a lower-melting component allows the application of the wear coating during brazing cycles of other portions of the structure, thereby reducing the number of heating cycles required and thence the production costs as compared with application techniques that require separate application cycles. The higher-melting second component may be either an abrasive material or a lubricious material. The approach may therefore be used to apply a wear-resistant coating having a second component that is either more abrasive than the first component or is more lubricious than the first component.

A wear-resistant coating mixture comprises a first component having a first-component solidus temperature and having a nominal composition in weight percent of (i) from about 6 to about 8 percent chromium, from about 2.5 to about 3.5 percent iron, from about 4 to about 5 percent silicon, from about 2.75 to about 3.5 percent boron, balance nickel and minor elements, or (ii) about 0.5 maximum percent iron, from about 4 to about 5 percent silicon, from about 2.75 to about 3.5 percent boron, balance nickel and minor elements, and a second component having a second-component solidus temperature greater than the first-component solidus temperature. The first component preferably has a nominal composition in weight percent of (i) about 82.9 percent nickel, about 7 percent chromium, about 3 percent iron, about 4.1 percent silicon, and about 3 percent boron, or (ii) about 92.4 percent nickel, about 0.2 percent iron, about 4.5 percent silicon, and about 2.9 percent boron.

The wear-resistant coating mixture may be in a “green” state where the first component has not been melted while in contact with the second component, or a sintered state where at least some of the first component has been melted in contact with the second component. Where the wear-resistant coating mixture is in the green state wherein the first component has not yet been melted, there is typically also present a binder, preferably an organic binder, that binds the first component and the second component together until the first component has been melted.

In one embodiment, the second component has a second-component abrasiveness greater than the first-component abrasiveness. In another embodiment, the second-component is more lubricious than is the first-component. An example of a more-abrasive second component is chromium carbide (CrC), and an example of a more-lubricious second component is a cobalt-base alloy such as Mar M509 or T800.

In another form, a wear-resistant coating mixture comprises a nickel-base alloy first component having a first-component solidus temperature of from about 1775° F. to about 1825° F., and a second component having a second-component solidus temperature greater than the first-component solidus temperature. The first component preferably has a nominal composition in weight percent of (i) from about 6 to about 8 percent chromium, from about 2.5 to about 3.5 percent iron, from about 4 to about 5 percent silicon, from about 2.75 to about 3.5 percent boron, balance nickel and minor elements, or (ii) about 0.5 maximum percent iron, from about 4 to about 5 percent silicon, from about 2.75 to about 3.5 percent boron, balance nickel and minor elements.

An article comprises a substrate having a surface, and a wear-resistant coating mixture applied to the surface of the substrate. The wear-resistant coating mixture comprises a nickel-base alloy first component having a first-component solidus temperature of from about 1775° F. to about 1825° F., and a second component having a second-component solidus temperature greater than the first-component solidus temperature. There may be a piece brazed to the substrate. Other compatible features as discussed above may be used with this embodiment.

A method for forming a structure comprises the steps of providing a substrate having a surface, and applying a wear-resistant coating mixture to the surface of the substrate as a wear-resistant coating layer. The wear-resistant coating mixture comprises a nickel-base alloy first component having a first-component solidus temperature of from about 1775° F. to about 1825° F., and a second component having a second-component solidus temperature greater than the first-component solidus temperature. The step of applying includes the step of heating the substrate and the wear-resistant coating mixture to a coating temperature greater than the first-component solidus temperature. The first component and the second component are preferably as described above, and other compatible features as described herein may be used with the method. There may be an additional step, conducted simultaneously with the step of applying, of brazing the substrate to another piece.

The present approach thus provides a wear-resistant coating mixture using a nickel-base lower-melting first component that has good strength and adherence properties to typical nickel-base substrates, in combination with a low melting point that results in good economics and reduced manufacturing costs as compared with lower-melting components that melt at increased temperatures.

Other features and advantages of the present invention will be apparent from the following more detailed description of the preferred embodiment, taken in conjunction with the accompanying drawings, which illustrate, by way of example, the principles of the invention. The scope of the invention is not, however, limited to this preferred embodiment.

### BRIEF DESCRIPTION OF THE DRAWINGS

FIG. 1 is a schematic sectional view of a substrate with a “green” wear-resistant coating mixture applied to the surface of the substrate;

FIG. 2 is a block flow diagram of a preferred approach for preparing and applying the wear-resistant coating mixture;

FIG. 3 is a schematic sectional view of the substrate with a sintered wear-resistant coating mixture applied to the surface of the substrate by the approach of FIG. 2; and

FIG. 4 is a schematic sectional view of a component that is being simultaneously brazed and coated in a single manufacturing step.

### DETAILED DESCRIPTION OF THE INVENTION

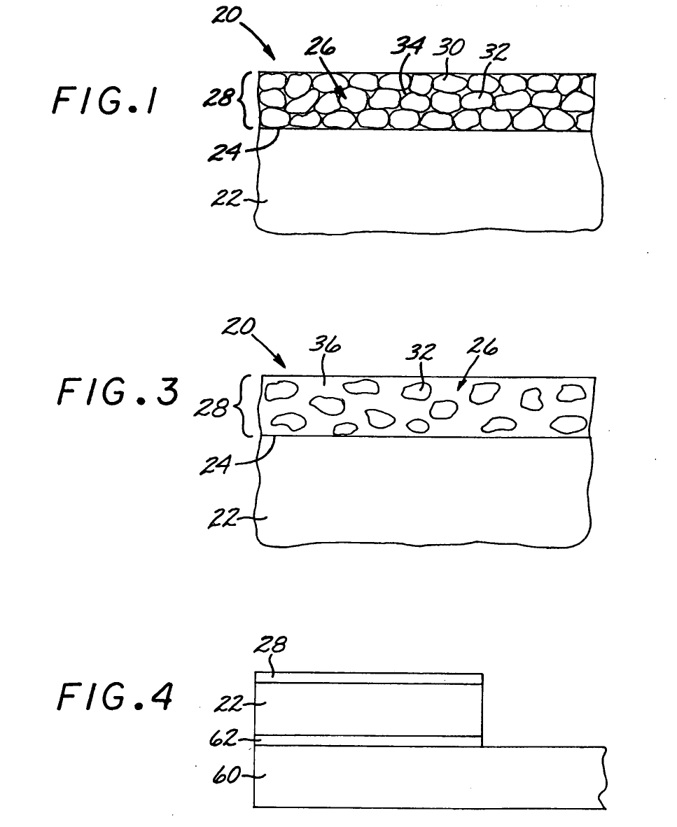

FIG. 1 depicts an article 20 that comprises a substrate 22 having a surface 24, and a wear-resistant coating mixture 26 applied as a wear-resistant coating layer 28 to the surface 24 of the substrate 22. The substrate 22 is preferably a component of a gas turbine engine such as a compressor vane sector. Examples of materials of construction of substrates 22 to which the wear-resistant coating layer 28 may be applied include Alloy 625 and Alloy 718.

The wear-resistant coating mixture 26 in its green form of FIG. 1 comprises a nickel-base alloy first component 30, a second component 32, and a third component 34. “Green”, as used herein in reference to the wear-resistant coating mixture, means that the first component 30 has not been melted in contact with the second component 32, and the third component 34 is present. The first component 30 and the second component 32 are in the form of small particles, typically of a particle size of −325 mesh. The third component 34 is a binder, preferably an organic binder that binds the first component 30 and the second component 32 together, and aids in adhering them to the surface 24.

The first component 30, which is a low-melting component as compared with the second component 32, has a first-component solidus temperature of from 1775° F. to 1825° F. This relatively low melting temperature for a nickel-base alloy allows the coating processing (to be described subsequently) to be conducted at a relatively low temperature that is compatible with brazing cycles used for other portions of the manufacture of the component. As used herein, a “nickel-base” alloy has more nickel (by weight) than any other element. Preferably, the nickel-base alloy first component 30 has at least 80 percent by weight nickel. The use of a large weight percentage of nickel makes the first component 30, which is melted during processing, compatible with a nickel-base substrate 22, the preferred application. Two preferred nickel-base alloys that may be used as the first component 30 have compositions in weight percent of (i) from 6 to 8 percent chromium, from 2.5 to 3.5 percent iron, from 4 to 5 percent silicon, from 2.75 to 3.5 percent boron, balance nickel and minor elements (alloy AMS 4777), with a preferred composition being 82.9 percent nickel, 7 percent chromium, 3 percent iron, 4.1 percent silicon, and 3 percent boron; or (ii) 0.5 maximum percent iron, from 4 to 5 percent silicon, from 2.75 to 3.5 percent boron, balance nickel and minor elements (alloy AMS 4778), with a preferred composition being 92.4 percent nickel, 0.2 percent iron, 4.5 percent silicon, and 2.9 percent boron. These compositions are preferably furnished in a prealloyed form. The first component 30 has a first-component solidus temperature. Both of these preferred nickel-base alloys have a solidus temperature of about 1800° F. The first nickel-base alloy has a liquidus temperature of about 1825° F. and a preferred coating temperature of about 1950+/−25° F. The second nickel-base alloy has a liquidus temperature of about 1875° F. and a preferred coating temperature of about 1950+/−25° F.

The second component 32 is of a different composition than the first component. The second component 32 has a second-component solidus temperature greater than the first-component solidus temperature. That is, there is an intermediate temperature range at which the first component 30 melts but the second component 32 does not melt. The coating temperature preferably lies in this intermediate temperature range. In a preferred application, the second component is selected according to whether the second-component is more abrasive than the first component, or whether the second component is more lubricious than the first component. An example wherein the second component is more abrasive than the first component is chromium-carbon material such as CrC. When CrC is used, it is preferably provided as a prealloyed powder of CrC and nickel-chromium metallic alloy to facilitate wetting of the melted first component to the CrC. A preferred composition in weight percent is 3.5-4.5 percent carbon, 7.0-9.0 percent nickel, 1.5 percent maximum manganese, 0.7 percent maximum iron, 1.5 percent maximum silicon, 2.0 maximum percent all other elements except chromium, balance chromium. An example of a second component wherein the second component is more lubricious than the first component is a cobalt-base alloy such as Mar M509, having a nominal composition in weight percent of about 0.6 percent carbon, about 0.1 percent manganese, about 0.4 percent maximum silicon, about 22.5-24.25 percent chromium, about 1.5 percent maximum iron, about 0.15-0.30 percent titanium, about 0.01 percent maximum boron, about 0.3-0.6 percent zirconium, about 9-11 percent nickel, about 6.5-7.5 percent tungsten, about 3-4 percent tantalum, balance cobalt and minor elements; or alloy T800, having a nominal composition in weight percent of from about 16.5 to about 18.5 percent chromium, from about 27 to about 30 percent molybdenum, about 3 to about 3.8 weight percent silicon, about 1.5 maximum percent iron, about 1.5 percent maximum nickel, balance cobalt, with minor elements also present.

Some preferred relative amounts of the second component 32 and the first component 30 in weight percents are from 18 to 30 percent, preferably from 25 to 27 percent, most preferably 27 percent CrC (chromium carbide), balance alloy 4778; from 10 to 20 percent, preferably from 14 to 16 percent, most preferably 15 percent alloy T800, balance alloy 4777; from 15 to 35 percent, preferably from 25 to 28 percent, most preferably 27 percent Mar M509, balance alloy 4777; and from 15 to 50 percent, preferably from 37 to 41 percent, most preferably 40 percent Mar M509, balance alloy 4778. These preferred relative amounts are selected so that the melted material has the proper fluidity, and to achieve an acceptable surface finish in the final solidified product.

The third component 34 of the green wear-resistant coating mixture 26 illustrated in FIG. 1 is the binder. The binder is preferably an organic material that aids in adhering and binding the first component 30 and the second component 32 together to each other and to the surface 24 during initial handling and in the green form on the substrate surface 24. Commercial materials such as Nicrobraze 520 and Nicrobraze 1000 may be used as the third-component 34, as these binders vaporize in a subsequent step leaving little residue. For a further discussion of these binders, see U.S. Pat. No. 5,705,281, whose disclosure is incorporated by reference herein.

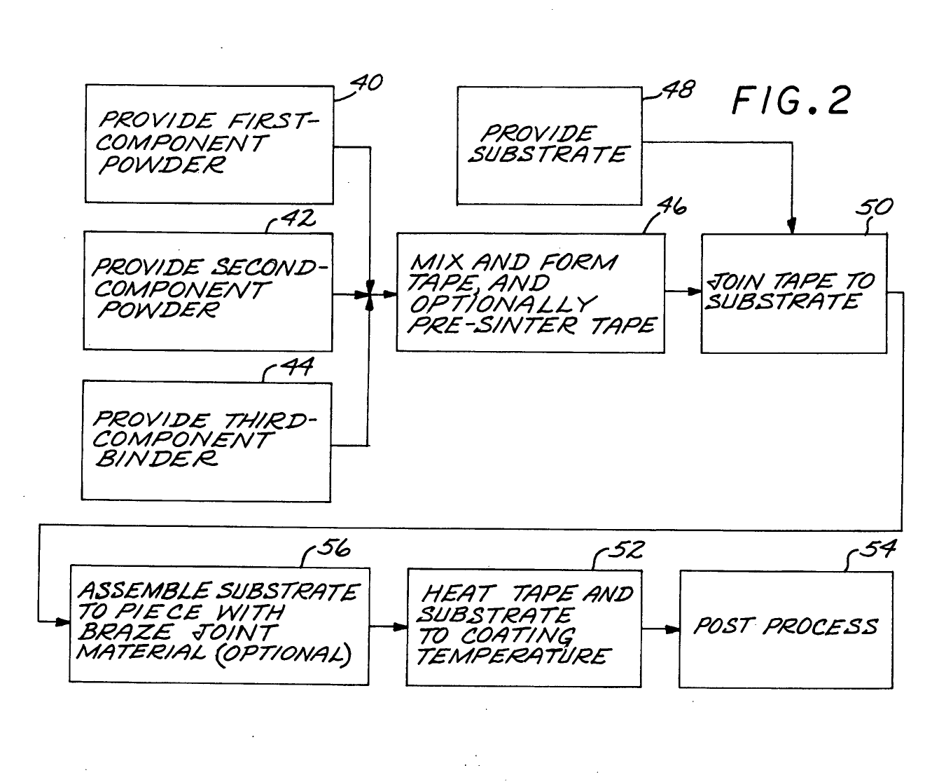

FIG. 2 illustrates the steps of a method for practicing the present approach. A powder of the first component 30 is provided, step 40; a powder of the second component 32 is provided, step 42, and the binder component 34 is provided, step 44. The components 30, 32, and 34 are as described previously. The relative proportions of the components 30 and 32 are preferably as described above. The binder third component 34 is typically about 10 percent by weight of the total weight of the first component 30 and the second component 32.

The three components 30, 32, and 34 are mixed together and, preferably, formed into a tape, step 46, by any operable approach, such as rolling, extrusion, doctor blade technique, or the like. The tape may be of any operable thickness and width. A preferred thickness is about 0.010 inches or less, and the tape is made as wide as necessary to cover the area to be coated. The tape may be made in short segments or substantially continuous, and in the latter approach appropriate lengths are cut off as needed.

The tape may be used in this “green” form wherein the first component has not been melted at all in the tape, or optionally fired to partially pre-sinter the tape. In the latter approach, the tape is heated to a pre-sintering temperature where a small portion of the first component partially melts but the second component does not melt. In this optional pre-sintering, the binder is vaporized. The binder is no longer needed, as the partially melted first component holds the remainder of the first component and the second component together with sufficient strength for subsequent handling and joining to the substrate.

The substrate 22 is provided, step 48. The substrate 22 is preferably made of a nickel-base alloy such as Alloy 625 or Alloy 718, although other types of alloys may be used as well. The green tape or pre-sintered tape prepared in step 46 is joined to the surface 24 of the substrate 22, step 50. At this stage, the joining of the green tape or pre-sintered tape to the surface 24 need be only sufficient to hold the tape in place for the initial stages of the next step. For some applications, a pressing onto the surface may be sufficient in step 50. In other applications, an adhesive such as Borden's SAF-T may be used as a temporary adhesive. The pre-sintered tape may be joined to the surface 24 by a tack weld such as produced by capacitor discharge welding.

The substrate 22 with the applied wear-resistant coating mixture of the components 30, 32, and 34 is heated to a coating temperature, step 52. For the preferred compositions of the first component 30 as discussed above, the preferred coating temperature is 1950+/−25° F. This coating temperature is significantly lower than those of other available alloys that may be used as the first component.

As the substrate 22 and green or pre-sintered tape are heated to the coating temperature, the binder third component 34 and the adhesive, if any, are vaporized and removed. Upon exceeding the solidus temperature of the first component 30, the first component begins to melt, but the second component 32 remains a solid. The liquid phase of the first component 30 begins to partially interdiffuse with the solid particles of the second component 32 and with the substrate material at the surface 24, forming metallurgical bonds. Upon subsequent solidification, a strong metallurgical bond is formed between the phases and the surface 24 as the sintered wear-resistant coating layer 28 is formed. This state is termed a “sintered” state, where the first component 30 has melted but the second component 32 and the substrate 22 have not melted, but there is a degree of interdiffusion due to the liquid phase of the first component 30.

FIG. 3 illustrates the article 20 with the first component 30 and the second component 32 sintered after step 52. The first component 30 is no longer in a particle form, but instead is a first-component matrix 36 that binds the particles of the second component 32 (which did not melt in step 52) to each other and to the surface 24 of the substrate.

The sintered wear-resistant coating layer 28 and substrate 22 are thereafter post processed as necessary. Post processing may include shaping the wear-resistant coating layer 28 as necessary, for example by grinding or machining. It may also include further heat-treating, cleaning, or other processing.

The present approach has been reduced to practice and comparatively tested for wear properties. In each case, a wear shoe made of Alloy 718 was coated with the indicated shoe coating. The coated shoe was worn in sliding friction against a block made of Alloy 718 and coated with T104CS material, at a temperature of 950° F. The stroke cycle was 0.005 inch length at 100 Hertz (Hz), followed by 0.100 inch length at 1 Hz. The T104CS material is a known wear-resistant coating made by electroplating a mixture of cobalt and chromium carbide that is the preferred conventional wear-resistant coating for many applications, and the remaining four shoe coatings are compositions prepared according to embodiments of the present approach.

| | Average. | Deepest | | |
|---|---|---|---|---|
| | Shoe | Shoe | Average | Deepest |
| Shoe Coating | Wear* | Pit* | Block Wear* | Block Pit* |
| T104CS | 0.165 | −0.538 | 0.248 | −0.648 |
| T104CS | 0.000 | −0.072 | −0.014 | −0.072 |
| 4778 + 27% CrC | 0.006 | −0.011 | 0.039 | 0.006 |
| 4777 + 15% T800 | 0.031 | 0.021 | 0.031 | 0.021 |
| 4777 + 27% Mar M509 | 0.038 | 0.000 | 0.038 | −0.076 |
| 4778 + 40% Mar M509 | 0.026 | −0.039 | 0.051 | 0.039 |

*measured as a stress-normalized value per square inch
A minus sign (−) indicates a pit, while a positive value indicates a buildup of material.

FIG. 4 illustrates the use of the present approach to produce a wear-resistant coating layer 28 on the substrate 22, simultaneously with the brazing of the substrate 22 to another piece 60. The method of FIG. 2 is used, except that prior to step 52 the substrate 22 is assembled into contact with the piece 60 with a braze joint 62 either prepositioned between the substrate 22 and the piece 60, or with the substrate 22 and the piece 60 spaced apart by a controlled distance, such as about 0.010 inch, and a reservoir of the braze material for the braze joint 62 adjacent to the gap between the substrate 22 and the piece 60, step 56. The braze material for the braze joint 62 is selected to have a brazing temperature compatible with the coating temperature of the wear-resistant coating mixture 26. In step 52, the first component 30 of the wear-resistant coating mixture 26 is melted to form the sintered wear-resistant coating layer 28 illustrated in FIG. 3, and simultaneously the braze material is melted to form the braze joint 62. Upon subsequent cooling from the coating temperature, the solid wear-resistant coating layer 28 and the solid braze joint 62 remain. More complex structures may be built by joining several substrates and pieces together by brazing, simultaneously with the wear-resistant coating of those portions of the structure that are subject to wear damage, in a single heating cycle. The substrate 22 may be joined to the piece 60 directly, as illustrated in FIG. 4, or indirectly with other elements of structure between the substrate 22 and the piece 60, as long as the wear-resistant coating layer 28 and the braze joint 62 are present and are preferably formed simultaneously as described. This combined joining and wear protection is an important cost-saving advance in the processing of subcomponents and components, since braze joining and wear protection with the wear-resistant coating layer are performed in a single step, rather than in multiple steps as with prior approaches.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A wear-resistant coating mixture comprising
a first component having a first-component solidus temperature and having a nominal composition in weight percent of (i) from about 6 to about 8 percent chromium, from about 2.5 to about 3.5 percent iron, from about 4 to about 5 percent silicon, from about 2.75 to about 3.5 percent boron, balance nickel and minor elements, or (ii) about 0.5 maximum percent iron, from about 4 to about 5 percent silicon, from about 2.75 to about 3.5 percent boron, balance nickel and minor elements; and
a second component having a second-component solidus temperature greater than the first-component solidus temperature.

2. The wear-resistant coating mixture of claim 1, further including
a binder third component that binds the first component and the second component together.

3. The wear-resistant coating mixture of claim 1, wherein the first component has a nominal composition in weight percent of about 82.9 percent nickel, about 7 percent chromium, about 3 percent iron, about 4.1 percent silicon, and about 3 percent boron.

4. The wear-resistant coating mixture of claim 1, wherein the first component has a nominal composition in weight percent of about 92.4 percent nickel, about 0.2 percent iron, about 4.5 percent silicon, and about 2.9 percent boron.

5. The wear-resistant coating mixture of claim 1, wherein the second component is a chromium-carbon material or a cobalt-base alloy.

6. The wear-resistant coating mixture of claim 1, wherein the first component and the second component are in the sintered state.

7. The wear-resistant coating mixture of claim 1, wherein the first component and the second component are in the green state.

8. The wear-resistant coating mixture of claim 1, wherein the first component has a first-component abrasiveness, and wherein the second component has a second-component abrasiveness greater than the first-component abrasiveness.

9. The wear-resistant coating mixture of claim 1, wherein the first component has a first-component lubricity, and wherein the second component has a second-component lubricity less than the first-component lubricity.

10. A wear-resistant coating mixture comprising
a nickel-base alloy first component having a first-component solidus temperature of from about 1775° F. to about 1825° F.; and
a second component having a second-component solidus temperature greater than the first-component solidus temperature.

11. The wear-resistant coating mixture of claim 10, wherein the first component has a nominal composition in weight percent of (i) from about 6 to about 8 percent chromium, from about 2.5 to about 3.5 percent iron, from about 4 to about 5 percent silicon, from about 2.75 to about 3.5 percent boron, balance nickel and minor elements, or (ii) about 0.5 maximum percent iron, from about 4 to about 5 percent silicon, from about 2.75 to about 3.5 percent boron, balance nickel and minor elements.

12. An article comprising:
a substrate having a surface; and
a wear-resistant coating mixture applied to the surface of the substrate, wherein the wear-resistant coating mixture comprises
a nickel-base alloy first component having a first-component solidus temperature of from about 1775° F. to about 1825° F.; and
a second component having a second-component solidus temperature greater than the first-component solidus temperature.

13. The article of claim 12, further including
a piece joined to the substrate by a braze joint.

14. The article of claim 12, wherein the first component has a first-component solidus temperature and has a nominal composition in weight percent of (i) from about 6 to about 8 percent chromium, from about 2.5 to about 3.5 percent iron, from about 4 to about 5 percent silicon, from about 2.75 to about 3.5 percent boron, balance nickel and minor elements, or (ii) about 0.5 maximum percent iron, from about 4 to about 5 percent silicon, from about 2.75 to about 3.5 percent boron, balance nickel and minor elements.

15. The article of claim 12, wherein the first component and the second component are in the sintered state.

16. The article of claim 12, wherein the first component and the second component are in the green state.

17. A method for forming a structure, comprising the steps of
providing a substrate having a surface; and
applying a wear-resistant coating mixture to the surface of the substrate as a wear-resistant coating layer, wherein the wear-resistant coating mixture comprises
a nickel-base alloy first component having a first-component solidus temperature of from about 1775° F. to about 1825° F., and
a second component having a second-component solidus temperature greater than the first-component solidus temperature, wherein the step of applying includes the step of heating the substrate and the wear-resistant coating mixture to a coating temperature greater than the first-component solidus temperature.

18. The method claim 17, including an additional step, conducted simultaneously with the step of applying, of
brazing the substrate to a piece.

19. The method of claim 17, wherein the step of applying includes providing the first component having a first-component solidus temperature and having a nominal composition in weight percent of (i) from about 6 to about 8 percent chromium, from about 2.5 to about 3.5 percent iron, from about 4 to about 5 percent silicon, from about 2.75 to about 3.5 percent boron, balance nickel and minor elements, or (ii) about 0.5 maximum percent iron, from about 4 to about 5 percent silicon, from about 2.75 to about 3.5 percent boron, balance nickel and minor elements.
